(19) United States
(12) Patent Application Publication
(10) Pub. No.: US 2007/0249420 A1
(43) Pub. Date: Oct. 25, 2007

(54) Localized Telephone Gaming System

(76) Inventor: Stephen Randall, Wellesley, MA (US)

Correspondence Address: BROMBERG & SUNSTEIN LLP, 125 SUMMER STREET, BOSTON, MA, 02110-1618, US

(21) Appl. No.: 11/735,335

(22) Filed: Apr. 13, 2007

Related U.S. Application Data
(60) Provisional application No. 60/744,863, filed on Apr. 14, 2006.

(51) Int. Cl. A63F 13/00; G06F 19/00

(52) U.S. Cl. 463/40; 463/41

(57) ABSTRACT

Game players interact with a game system using mobile devices, such as mobile telephones, without violating the Federal Wire Act. The game system ensures that a player is within the same state as the game system, with which the player interacts. A player's inputs may be associated with a fixed-location display screen. Unique identifying information is displayed on fixed-location screens or on groups of co-located screens, such as screens co-located in a betting parlor, and the player is required to enter the identifying information or use the identifying information to establish a connection with the game system. Alternatively, the game system associates the player's input with the player's mobile device. A player records a telephone number of the player's mobile device on a game card, and the game card 130 is read by a card reader/receipt printer. Upon reading the game card, the game system stores the telephone number of the player's mobile device and thereafter associates payer inputs with the mobile device identified by the game card.

### CROSS REFERENCE TO RELATED APPLICATIONS

This application claims the benefit of U.S. Provisional Patent Application No. 60/744,863, filed Apr. 14, 2006, titled “Localized Phone Gaming System,” the contents of which are hereby incorporated by reference herein.

### TECHNICAL FIELD

The present invention relates to game systems and, more particularly, to game systems in which mobile devices, such as mobile telephones, may be used to interact with the game systems.

### BACKGROUND ART

In the United States, many lotteries and other similar games are controlled by states. These games include Keno, Powerball and various “scratch-card” games. A player may participate in one of these games by purchasing a game card at a betting parlor or other retailer. The player learns whether the player has won or lost the game by reading winning numbers listed in a newspaper, observing winning numbers displayed on a screen in the betting parlor, observing winning numbers being drawn during a live television broadcast, removing obscuring material from a scratch-card or the like.

Interactive games are considered by some players to be more interesting than games that require waiting for a winner, or a winning combination of numbers, to be chosen. An example of an interactive game is a slot machine. While an interactive game may be more exciting to play than a scratch-card game, typically only one player at a time may play a slot machine or similar game. This feature limits the number of players who may play such a game over the course of a day and the amount of revenue the game may generate.

Some game operators may prefer to introduce an element of interactivity into traditional lottery games. One possible device that may provide a user interface to an interactive lottery game is a mobile telephone. However, federal regulations limit or prohibit the operation of certain types of betting businesses in the United States. For example, the “Federal Wire Act” prohibits using a “wire communication facility” for the transmission in interstate or foreign commerce of certain types of bets or wagers or information assisting in the placing of bets or wagers. Consequently, using a mobile telephone to interact with a lottery system may violate the Federal Wire Act, at least if the caller and the called lottery system are in different states.

### SUMMARY OF THE INVENTION

An embodiment of the present invention provides a method for operating a game. The method includes displaying indicia corresponding to a plurality of game options on a fixed-location screen. The method also includes receiving an indication of a selection of at least one of the plurality of game options from a mobile device via a wireless link and determining if the mobile device is within a predetermined geographic area that contains the fixed-location screen. If the mobile device is within the predetermined geographic area, a game status is determined based on the received indication.

Determining if the mobile device is within a predetermined geographic area may include associating the received indication with the fixed-location screen. Associating the received indication with the fixed-location screen may include displaying identifying information associated with the fixed-location screen on the fixed-location screen and receiving the identifying information in association with the received indication.

Optionally, the displayed identifying information is repeatedly revised, such as at least once per day.

Displaying the identifying information may include displaying a telephone number, and receiving the indication may include receiving the indication of the selection of the at least one of the plurality of game options via a telephone call placed by the mobile device to the telephone number.

Displaying the identifying information may include displaying a text message address, and receiving the indication may include receiving the indication of the selection of the at least one of the plurality of game options via a text message sent by the mobile device to the text message address.

Displaying the identifying information may include displaying at least one character, and receiving the identifying information may include receiving an indication of a button press on the mobile device corresponding to each of the at least one character or receiving an oral command corresponding to the at least one character and spoken into the mobile device.

Associating the received indication with the fixed-location screen may include determining a geographic location of the mobile device and correlating a location of the fixed-location screen with the location of the mobile device.

Receiving the indication of the selection may include receiving an indication of a button press on the mobile device, receiving a plurality of mobile device button press indications or receiving an oral command spoken into the mobile device.

Optionally, an image displayed on the fixed-location screen in response to receiving the indication of the selection may be modified.

Optionally, if the game status indicates a win, an image displayed on the fixed-location screen may be modified, such as by displaying an indication of a prize associated with the win.

Optionally, the method may include accepting a payment for playing the game and associating the payment with the mobile device.

An account associated with the mobile device may be debited for playing the game.

If the game status indicates a win, a prize may be awarded or an account associated with the mobile device may be credited with a prize. At least a portion of a prize associated with the win may be allocated to a cost associated with a subsequent game.

Receiving the indication of a selection of at least one of the plurality of game options and determining a game status based on the received indication may be repeated until the game status corresponds to an end of the game.

Displaying the indicia may include displaying the indicia corresponding to the plurality of game options on each of a plurality of fixed-location screens, and associating the received indication may include associating the received indication with one, or fewer than all, of the plurality of fixed-location screens.

Optionally, an audio signal may be sent via the wireless link to the mobile device for rendition by the mobile device. The audio signal may include a verbal prompt related to selecting the at least one of the plurality of game options,

A second indication of a second selection of at least one of the plurality of game options may be received from a second mobile device via a second wireless link. In this case, the received second indication may be associated with the fixed-location screen, and a second game status may be determined, based on the received second indication.

The received indication may be distinguished from the second received indication based on a first calling telephone number associated with the mobile device and a second calling telephone number associated with the second mobile device.

A method according to claim 26, further comprising automatically determining the first calling telephone number and the second calling telephone number. The received indication may be distinguished from the second received indication based on a first mobile identification number associated with the mobile device and a second mobile identification number associated with the second mobile device.

Optionally, a first avatar is displayed on the fixed-location screen to represent a first user of the mobile device, and a second avatar, different than the first avatar, is displayed on the fixed-location screen to represent a second user of the second mobile device.

Another embodiment of the present invention provides a method for operating a game. The method includes storing identifying information about a wireless mobile device. The method also includes receiving an indication of a selection of at least one game option from the mobile device via a wireless link and determining a game status based on the received indication. If the game status indicates a win, the stored identifying information may be used to award a prize.

Optionally, indicia corresponding to a plurality of game options may be displayed on a fixed-location screen.

Storing the identifying information may include storing at least a portion of a telephone number of the wireless mobile device or at least a portion of a text messaging address of the wireless mobile device.

Yet another embodiment of the present invention provides a method for operating a game. The method includes reading data recorded on a card. The data identifies a mobile device. The method also includes displaying indicia corresponding to a plurality of game options on a fixed-location screen and receiving an indication of a selection of at least one of the plurality of game options from the mobile device via a wireless link. The method includes associating the received indication with the mobile device identified by the data recorded on the card and determining a game status based on the received indication.

Optionally, the method determines if the mobile device is within a predetermined geographic area that contains the fixed-location screen. If the mobile device is within the predetermined geographic area, the game status may be determined based on the received indication.

Receiving the indication may include receiving the indication of the selection of the at least one of the plurality of game options via a communication from the mobile device, and associating the received indication with the mobile device may include correlating the read data recorded on the card with information provided in association with the communication from the mobile device.

Reading data recorded on a card may include reading a telephone number, a mobile identification number or a text messaging address of the mobile device recorded on the card and associating the received indication with the mobile device may include correlating the read telephone number, the mobile identification number or the text messaging address of the mobile device recorded on the card with a calling telephone number, mobile identification number or a text messaging address provided in association with the communication from the mobile device.

Optionally, identifying information associated with the fixed-location screen may be displayed on the fixed-location screen, and the identifying information may be received in association with the received indication.

Displaying the identifying information may include displaying a telephone number or a text message address, and receiving the indication may include receiving the indication of the selection of the at least one of the plurality of game options via a telephone call placed by the mobile device to the telephone number or a text message sent by the mobile device to the text message address.

Displaying the identifying information may include displaying at least one character, and receiving the identifying information may include receiving an indication of a button press on the mobile device corresponding to each of the at least one character or an oral command corresponding to the at least one character and spoken into the mobile device.

Optionally, the received indication may be associated with the fixed-location screen, such as by displaying identifying information associated with the fixed-location screen on the fixed-location screen and receiving the identifying information in association with the received indication.

Displaying the identifying information may include displaying a telephone number, a text message address or at least one character. The indication of the selection of the at least one of the plurality of game options may be received via a telephone call placed by the mobile device to the displayed telephone number or via a text message sent by the mobile device to the displayed text message address or an indication of a button press on the mobile device corresponding to each of the at least one character or an oral command corresponding to the at least one character and spoken into the mobile device.

The received indication may be associated with the fixed-location screen by determining a geographic location of the mobile device and correlating a location of the fixed-location screen with the location of the mobile device.

The indicia corresponding to the plurality of game options may be displayed on each of a plurality of fixed-location screens, and associating the received indication may include associating the received indication with one, or with fewer than all, of the plurality of fixed-location screens.

The indication of the selection may be received as an indication of a button press on the mobile device, as a plurality of mobile device button press indications or as an oral command spoken into the mobile device.

Optionally, an image displayed on the fixed-location screen may be modified in response to receiving the indication of the selection.

If the game status indicates a win, an image displayed on the fixed-location screen may be modified, such as by displaying an indication of a prize associated with the win.

A payment for playing the game may be accepted and associated with the mobile device.

An account associated with the mobile device may be debited for playing the game.

If the game status indicates a win, a prize may be awarded or an account associated with the mobile device may be credited with a prize. At least a portion of a prize associated with the win may be allocated to a cost associated with a subsequent game.

Receiving an indication of a selection of at least one of the plurality of game options from the mobile device via a wireless link, associating the received indication with the mobile device identified by the data recorded on the card and determining a game status based on the received indication may be repeated until the game status corresponds to an end of the game.

Optionally, an audio signal may be sent via the wireless link to the mobile device for rendition by the mobile device. The audio signal may include a verbal prompt related to selecting the at least one of the plurality of game options.

The method may include reading second data recorded on a second card, the second data identifying a second mobile device, receiving a second indication of a second selection of at least one of the plurality of game options from a second mobile device via a second wireless link, associating the received second indication with the second mobile device identified by the second data recorded on the second card and determining a second game status based on the received second indication.

Optionally, the received indication may be distinguished from the second received indication based on a first calling telephone number or a first mobile identification number associated with the mobile device and a second calling telephone number or second mobile identification number associated with the second mobile device. The first calling telephone number or first mobile identification number and the second calling telephone number or second mobile identification number may be automatically determined.

Optionally, a first avatar may be displayed on the fixed-location screen to represent a first user of the mobile device, and a second avatar, different than the first avatar, may be displayed on the fixed-location screen to represent a second user of the second mobile device.

Reading the data may include reading a telephone number or a mobile identification number of the mobile device recorded on the card.

Optionally, the data recorded on the card is read a second time. If the status indicates a win, a prize is awarded in response to reading the data recorded on the card the second time.

Optionally, a receipt associated with the mobile device identified by the data recorded on the card is provided. Data recorded on the receipt is read. If the status indicates a win, a prize is awarded in response to reading the data recorded on the receipt.

An embodiment of the present invention provides a game system for interacting with a mobile device via a wireless network. The game system includes a gateway for coupling to the wireless network and a fixed-location display screen A game server is coupled to the gateway and to the fixed-location display screen. The game server is programmed to display indicia corresponding to a plurality of game options on the display screen and receive an indication of a selection of at least one of the plurality of game options from the mobile device via the wireless network. The game server determines if the mobile device is within a predetermined geographic area that contains the fixed-location screen If the mobile device is within the predetermined geographic area, the game server determines a game status based on the received indication.

The game server may be programmed to associate the received indication with the fixed-location screen.

The game server may be further programmed to associate the received indication with the fixed-location screen by displaying identifying information associated with the fixed-location screen on the fixed-location screen and receiving the identifying information in association with the received indication.

The displayed identifying information may include a telephone number, a text message address or at least one character.

Optionally, the game system may include a card reader coupled to the game server and operative to read data recorded on a card. The data identifies the mobile device. The game server may be further programmed to associate the received indication with the mobile device identified by the data recorded on the card.

The data identifying the mobile device may be a telephone number, a mobile identification number (MIN) or a text messaging address.

### BRIEF DESCRIPTION OF THE DRAWINGS

The invention will be more fully understood by referring to the following Detailed Description of Specific Embodiments in conjunction with the Drawings, of which:

FIG. 1 is a schematic diagram of an exemplary context in which a game system may operate, according to some embodiments of the present invention;

FIG. 2 is a schematic representation of a display screen on which an exemplary in-progress game is displayed, according to one embodiment of the present invention;

FIG. 3 is a block diagram of a gateway of FIG. 1, according to one embodiment of the present invention;

FIG. 4 is a schematic representation of a display screen on which another exemplary in-progress game is displayed, according to one embodiment of the present invention;

FIG. 5 is a schematic representation of the display screen of FIG. 4 at a more advanced stage of the in-progress game;

FIG. 6 is a schematic diagram of a game card, according to one embodiment of the present invention;

FIG. 7 is a schematic diagram of another exemplary context in which a game system may operate, according to some embodiments of the present invention;

FIG. 8A-D is a flowchart illustrating operation of a game system, according to one embodiment of the present invention; and

FIG. 9A-E is a flowchart illustrating operation of a game system, according to another embodiment of the present invention.

### DETAILED DESCRIPTION OF SPECIFIC EMBODIMENTS

The contents of the following documents are hereby incorporated by reference herein: U.S. Provisional Patent Application No. 60/744,863, filed Apr. 14, 2006, titled “Localized Phone Gaming System,” U.S. patent application Ser. No. 11/275,939, filed Feb. 6, 2006, titled “A System and Method for Location-Based Interactive Content;” U.S. Provisional Patent Application No. 60/650,485, filed Feb. 6, 2006, titled “A System and Method for Location-Based Interactive Content;” PCT Patent Application No. PCT/US2005/040186, filed Nov. 4, 2005, titled “A System and Method for Interactive Marketing;” U.S. Provisional Patent Application No. 60/624,712, filed Nov. 4, 2004, titled “A System and Method for Interactive Marketing” and U.S. Provisional Patent Application No. 60/903,742, filed Feb. 26, 2007, titled “Systems and Methods for Interactive Games.”

### DEFINITIONS

As used in this description and the accompanying claims, the following terms shall have the meanings indicated, unless the context otherwise requires:

An “avatar” is a player's representation of himself or herself, such as in the form of a three-dimensional model used in computer games, a two-dimensional icon used on Internet forums and other communities or display screens or a text construct found on early systems, such as multi-player computer games. The term “avatar” may also refer to a screen name, or handle, of a player.

A “win” is a situation in a game, according to rules of the game. A win may be determined by chance, skill, timing, one or more other parameters or a combination thereof, as specified by the rules. A game may have zero or more winners.

A “prize” is a benefit, to which a game player becomes entitled as a consequence of winning the game. A game administrator may impose requirements, such as a minimum age for a player or a time limit within which a prize must be claimed by a player, which are considered to be included in the game rules. A prize may be tangible or intangible, including (without limitation) a product (such as an automobile), an amount of money in the form of cash or credit, a service (such as a hotel accommodation) or an opportunity to play the same or another game for free or at a reduced cost. Not all winners of a game are necessarily entitled to identical or equal-valued prizes.

### Localized Telephone Gaming System Architecture

In accordance with preferred embodiments of the present invention, methods and apparatus are disclosed for operating a game in which a player (also referred to as a “user”) interacts with the game using a mobile device, such as a mobile telephone, without violating the Federal Wire Act. The systems and methods ensure that a player is within the same state as the game system, with which the player interacts.

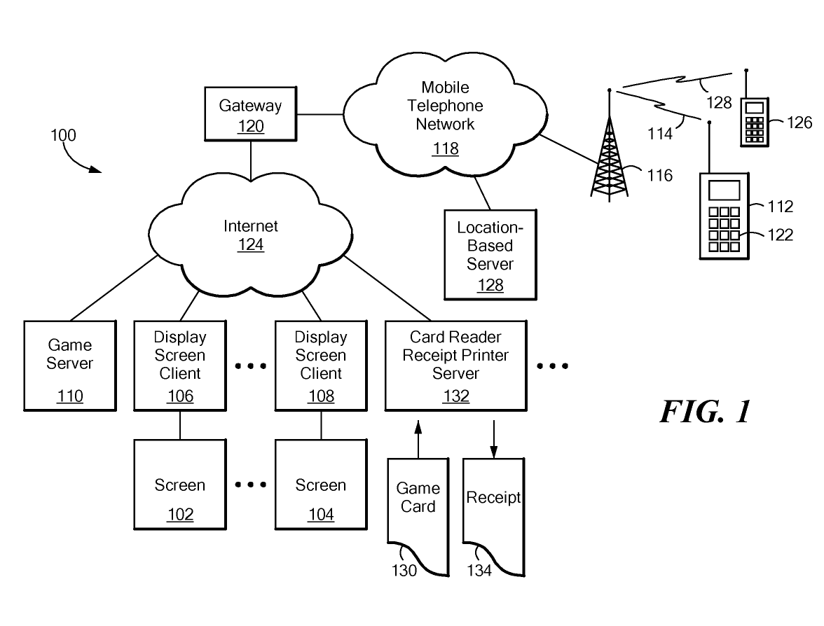

FIG. 1 is a schematic diagram of an exemplary context in which a game system 100 may operate, according to some embodiments of the present invention. The game system 100 includes one or more fixed-location i.e., non-mobile, display screens 102, 104, etc., on which aspects of one or more games are displayed. For example, Keno game numbers selected by a player and game numbers drawn by the game system 100 may be displayed on one or more of the screens 102-104. The screens 102-104 are controlled by screen clients 106, 108, etc. The screen clients 106-108 are coupled to a game controller 110, which controls operation of one or more games and determines contents to be displayed on the screens 102-104. These and other elements of the game system 100 are described in more detail below.

A player uses a mobile device 112, such as a mobile telephone, to establish a session and interact with the game system 100. The mobile device 112 communicates via a wireless link 114 to a base station 116 and via a communication network, such as a mobile telephone network 118, to a gateway 120. For example, if the mobile device 112 is a mobile telephone, the player dials a telephone number associated with the gateway 120. A multi-line hunt group or similar system (not shown) enables multiple mobile devices 112, 126 to establish simultaneous telephone calls to the gateway 120 after dialing a common telephone number. As described in more detail below, separate telephone numbers may be associated with ones of the screens 102, 104 or with games displayed on the screens 102-104. Thus, the game system 100 may use a called telephone number (as provided by a dialed number identification service (DNIS) or similar system) to determine with which screen 102, 104 or game a player wishes to interact.

The gateway 120 receives the calling mobile telephone's 112 telephone number from a calling line identification (CLI) service, or the like. The gateway 120 associates a game player with the player's mobile telephone number. Thus, if a telephone connection is broken and the player places a second telephone call to the gateway 120 from the same mobile telephone 112, the gateway associates the second telephone call with the player and resumes the player's session. The player's mobile telephone number may also be used for other purposes, such as associating the player with an account that is debited (such as to pay for games) or credited (such as with prizes that the player wins).

The gateway 120 accepts indications of player inputs, such as dual-tone multi-frequency (DTMF) tones generated by the mobile device 112 in response to key presses on a keypad 122 of the mobile device 112 or utterances spoken into the mobile device 112. The player inputs may include selections of game options, such as Keno game numbers.

The gateway 120 sends messages via a computer network, such as the Internet 124, to the game server 110 to notify the game server 110 of player inputs. These messages may include the telephone number dialed by the player or an indication of the screen 102, 104 or the game associated with the dialed number. In addition, these messages may include the telephone number of the calling mobile device 112 or another identification of the mobile device 112 or the player associated with the telephone number of the calling mobile device 112.

Upon receiving a command from the game server 110, the gateway 120 may provide instructions or responses to the player, such as in the form of tones or pre-recorded or synthesized speech, music or other audio signals that are sent back over the mobile telephone network 118 and wireless link 114 to the mobile device 112 for rendition thereby. Thus, a connection is established between the player's mobile device 112 and the game server 110 for receiving inputs from the player and for providing outputs to the player. It should be noted that no special hardware or software is required to be present on the mobile device 112 to enable a player to use the mobile device 112 to interact with the game system 100.

Another mobile device, such as a second mobile telephone 126, may communicate with the gateway 120 using a second wireless link 128 and the same base station 116 or another base station (not shown) and the same mobile telephone network 118 or another communication network (not shown). The two mobile devices 112 and 126 may use different modes of communication with the gateway 120. For example, one of the mobile devices 112 may place a voice telephone call to the gateway 120, and the other mobile device 126 may exchange instant (text) messages (IMs) with the gateway 120 (as described in more detail below). Optionally, the game system 100 may include one or more additional gateway proxies (not shown). Thus, multiple players may interact with the game server 110 to play a common multi-player game or separate single-player or multi-player games.

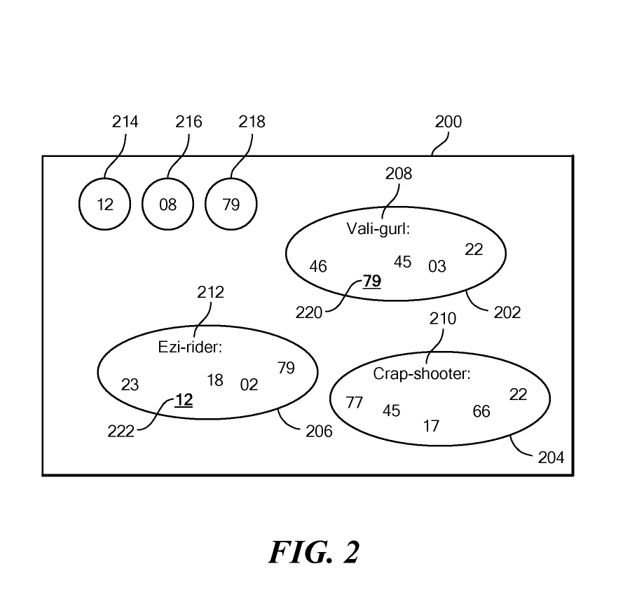

A single screen 102 or 104 may display information that is relevant to one or more players. For example, FIG. 2 is a schematic representation of a display screen 200, on which an in-progress Keno game is displayed. Game numbers selected by three players are displayed in three respective areas 202, 204 and 206, along with avatars 208, 210 and 212 representing the players. Numbers drawn by the game server 110 are indicated at 214, 216 and 218. Player-selected numbers that match numbers drawn by the game server 110 may be highlighted, such as by underlining, bolding, use of color, animation and the like, as indicated at 220 and 222. Thus, in addition or as an alternative, to audio output to a player, a screen 102, 104 provides visual output to the player Player inputs, such as key presses on the keyboard 122 of the mobile device 112, enable the player to interact with the game system 100 via a screen 102, 104 (FIG. 1), and the game system 100 may modify an image displayed on a screen 102, 104 in response to receiving an indication of a selection of a game option from the player's mobile device 112.

A single screen 102 or 104 may display information that is relevant to one or more games. For example, a screen 102, 104 may be divided into overlapping or non-overlapping areas, and each area may display information that is relevant to a separate game.

Unlike screens on mobile telephones, the screens 102-104 of the game system 100 are not mobile. That is, the screens 102-104 cannot be transported great distances while they are in use. The screens 102-104 may, however, be tilted, swiveled and pivoted, and a screen 102, 104 may be moved short distances, including within the area of a tabletop, while in use. The screens 102-104 may be conventional CRT, flat panel or projected computer and television monitors or any suitable display devices. The term “screen” includes other suitable output devices, such as three-dimension (3-D) goggles, refreshable Braille displays, other tactile output devices and audio output devices. The screens 102-104 are preferably large enough to be effectively simultaneously viewed by several or many people, although smaller screens, including single-player screens, are acceptable. Not all the screens 102-104 need to be the same size. The screens 102-104 may be disposed in betting parlors, retail stores, store windows, kiosks, malls and other indoor or outdoor venues.

Each screen 102-104 may be controlled by a separate screen client 106, 108, etc., or one screen client 106, 108 may control several screens 102, 104. The screen clients 102, 104 cause their respective screens 102, 104 to display images in response to messages received by the screen clients 106, 108, as described herein. Each screen 102, 104 may display unique contents, or several screens 102, 104 may display identical or overlapping contents. A screen 102, 104 may be connected to its screen client 106, 108 by any suitable wired or wireless link, such as a red-green-blue (RGB) analog cable or a computer network connection, using any suitable signal or protocol Each screen 102, 104 may, but need not, include a processor.

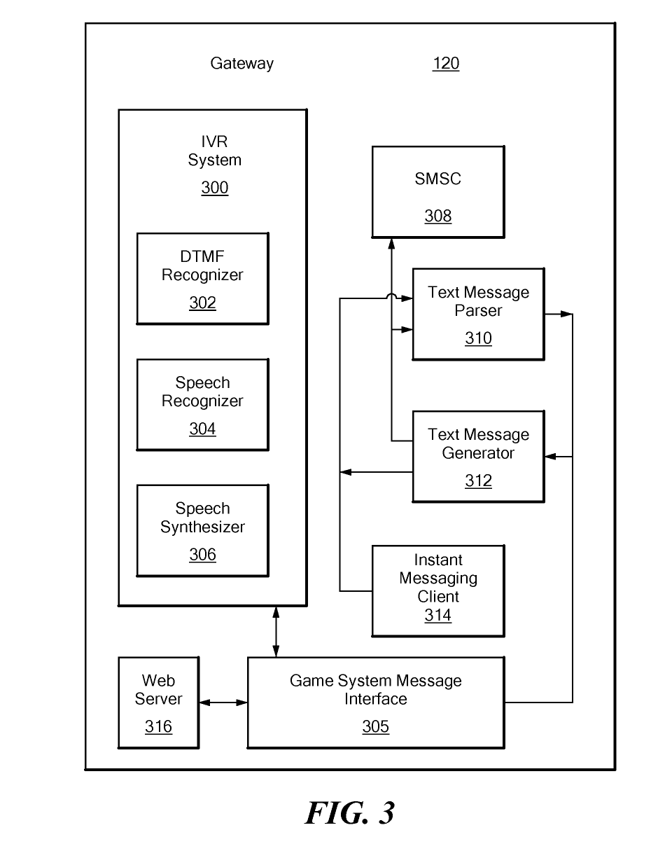

FIG. 3 is a block diagram of the gateway 120. As noted, once a connection is established between a player's mobile device 112 and the game server 110, the player may make a selection by pressing a keypad button on the mobile device. To facilitate interactions with a mobile telephone or similar type of mobile device, the gateway 110 may include an interactive voice response (IVR) subsystem 300. The IVR subsystem 300 includes a DTMF recognizer 302 for detecting and recognizing DTMF tones generated by the mobile device and/or a speech recognizer 304 for recognizing spoken utterances. Of course, the DTMF recognizer 302 and the speech recognizer 304 may be combined, as is well known in the art. When the IVR subsystem 300 recognizes a DTMF tone or a spoken utterance, the IVR subsystem 300 sends a message, via a game system message interface 305, to the game server 110. Thus, the player may make selections by pressing buttons and/or uttering spoken commands, such as numbers or other words or phrases, into the mobile device 126.

The IVR subsystem 300 may also include a speech synthesizer 306 for generating prompts, messages, etc. for rendition by the mobile device 112. The IVR subsystem 300 may include a tone generator (not shown) and/or a memory (not shown), in which representations of pre-recorded sounds are stored. Of course, the tone generator and/or the memory may be external to the IVR subsystem 300 and may be connected to the IVR subsystem 300 via a suitable link. The game server 110 sends messages, via the game system message interface 305, to the IVR subsystem 300 to instruct the IVR subsystem 300 to play the tones, pre-recorded sounds or to synthesize speech.

In some embodiments, the gateway 120 includes a short message service center (SMSC) 308, thus allowing a player to send indications of selections to the game server 110 via text messages and to receive responses from the game server 110 via text messages. Alternatively, a separate SMSC (not shown) may be coupled, directly or via a network and/or other intervening components, to the gateway 120. The SMSC 308 receives short message service (SMS) text messages from the player's mobile device 112, and the SMSC 308 routes the messages to a text message parser 310. The text message parser 310 parses the messages for text that corresponds to a selection of a game option, such as a Keno game number. When the message parser 310 recognizes a selection, or a potential selection or another player input, the message parser 310 sends a message containing the player's input, via the game system message interface 305, to the game server 110. Similarly, the game server 110 sends messages, via the game system message interface 305, to a text message generator 312 to instruct the text message generator 312 to send a text message to the player's mobile device 112.

In some embodiments, the gateway 120 includes an instant messaging (IM) client 314, which receives and sends instant messages from and to a player's mobile device 112. In other respects, the IM client's 314 operation is similar to that of the SMSC 308.

Optionally or alternatively, the gateway 110 includes interfaces (not shown) to other mobile communication services, such as a multimedia messaging service (MMS) or electronic mail (e-mail). Non-limiting examples of connections that may be established between the mobile device 112 and the gateway 110 include packet-switched and circuit-switched connections. (It should be noted that, although the term “connection” is used in conjunction with this function, a “connectionless” protocol may be used to send messages to the game system 100 or to the mobile device 112.) The other interfaces are coupled to the DTMF recognizer 302, speech recognizer 301, speech synthesizer 306, message parser, 310 message generator 312 and/or other user input handlers (not shown) and user output generators (not shown), as needed and as appropriate for the mobile communication services.

For simplicity of explanation, operations of portions of the present invention are described in relation to a player using a mobile telephone to place a call to the game system 100. The mobile telephone is identified by a mobile telephone number, although other information, such as a mobile identification number (MIN), may be used to identify the mobile telephone. The mobile telephone connects to the game system 100 by placing a telephone call to a telephone number of the game system 100. Thus, source and destination information relative to inputs from the player or the mobile device 112, are expressed in terms of telephone numbers.

However, as noted, other modes of communication between the mobile device 112 and the game system 100, as well as other types of mobile devices 112, may be used. For example, the mobile device 112 may establish a connection with the game system 100 by sending a message to an SMS address, to an IM address, to an e-mail address or the like. The mobile device 112 may be a wireless personal digital assistant (PDA), such as a BlackBerry device available from Research in Motion Limited, Waterloo, Ontario, Canada. Similarly, a web browser may establish a connection with the game system 100 by sending a request to an Internet protocol (IP) address. Thus, source and destination information for these other modes and other devices may take forms other than a telephone number. For example, source and destination information for IN messages may take the form of IM addresses. It should be recognized, therefore, that where a description is given in terms of a telephone number, other types of identifying information may be used.

The screen clients 102-104 are coupled to the game server 110 via any suitable link(s), including local- and/or wide-area network links, such as the Internet 124. The game server 110 controls operation of one or more games. A “game” includes a set of one or more interactions between a player and the game server 110, according to a set of rules. As noted, in an exemplary interaction a player selects a Keno game number by pressing one or more keys on the keypad 122 of the player's mobile device 112. In a single-player game, the player perceives himself/herself as being the only player in the game, although other players may be playing in the same game. The other players' interactions may not influence a win/lose outcome of the game, although the number of winners may influence the values of prizes awarded to the winners. In a multi-player game, each player perceives the fact that other players are playing in the game, although the player may not perceive all or any actions taken by the other players. A player's interactions may, but do not necessarily, influence a win/lose outcome for another player.

The game server 110, gateway 110, and/or screens 102-104, or portions thereof, may be implemented according to teachings of the above-referenced and incorporated by reference documents.

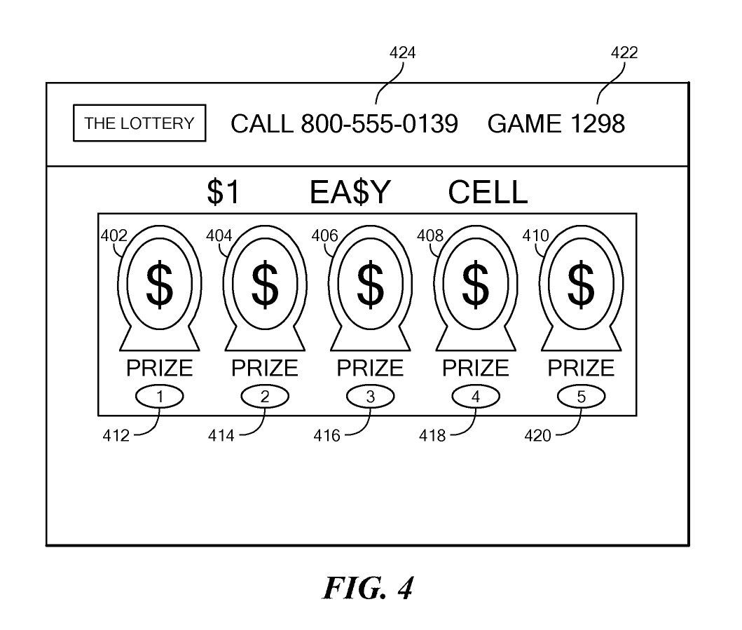

At the start of a game, the game server 110 (FIG. 1) may display initial information on one or more of the screens 102, 104 by sending messages to the appropriate screen client(s) 106, 108. For example, for a “scratch-card” game, the game server 110 may send messages causing each of one or more of the screens 102-104 to display an image similar to a screen display shown schematically in FIG. 4, in which dollar signs (“$”) 402, 404, 406, 408 and 410 correspond to options that may be selected by a player. Each option 402-410 may correspond to a numbered keypad button and/or to a spoken number, as indicated by legends 412, 414, 416, 418 and 420. The player may select one of the dollar signs 402410 to “scratchy” i.e., “uncover,” a spot on the game to reveal a prize or an indication that uncovering that spot did not entitle the player to a prize. In some such games, selecting a non-winning option entitles the player to continue selecting additional options. However, in some variations, selecting any non-winning indication, or a certain type of non-winning indication, immediately ends the game. Collectively, the dollar signs 402-410 and the legends 412-420 are indicia corresponding to the game options.

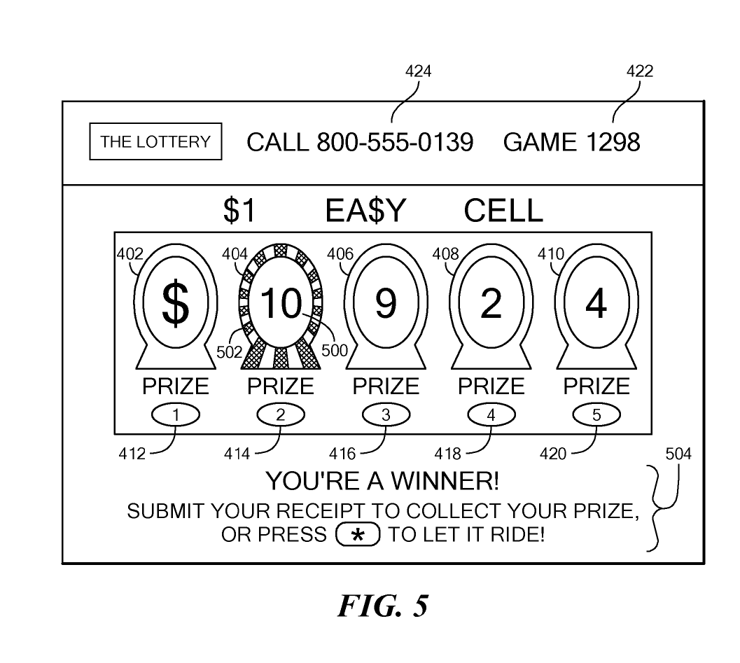

After a player interaction, the game server 110 determines a “status” of the game. The status may indicate that the player won the game, the game ended without the player winning, the game has not yet ended, i.e., more player interactions are possible in the current game, or some other status. For example assume, as shown in FIG. 5, that a player selected game option 404 by pressing a “I” key on the mobile device 112, by uttering the word “one” into the mobile device 112 or by sending an SMS or IN message containing the character “1.” The game server 110 modifies the image displayed on a fixed-location screen 102, 104, with which the player is interacting, to reveal a “10,” as indicated at 500. Because a “10” in any spot is defined by the game rules as a “win,” the game server 110 modifies the image displayed on the fixed-location screen as indicated by a border 502 and text 504. As indicated by the text 504, the player may collect a prize or press a “*” (asterisk) key on the mobile device 112 to use the prize to pay for a subsequent game, i.e., to “let it (the prize) ride.”

Prizes may be paid out in cash or by crediting an account associated with the player or the mobile telephone number associated with the player's mobile device 112. Similarly, a player may pay to play a game by surrendering cash or debiting such an account.

### Regulation-Compliant Betting via Mobile Device

The game system 100 (FIG. 1) may ensure that a player is within the same state (or any other predetermined geographic area) as the game server 110 or the screen 102, 104 when the player interacts with the game system 100. Thus, no interstate or foreign commerce is involved, and the player may place bets over the player's mobile device 112, without violating the Federal Wire Act. Several embodiments of methods and apparatus are disclosed for ensuring that the player is within the same state as the game server 110 or the screen 102, 104.

### Associating a Player's Input with a Fixed-Location Screen

A player's inputs may be associated with a fixed-location screen 102, 104. If the player's mobile device's location is known to be within the same state as the fixed-location screen 102, 104, the player may be permitted to place a bet.

In one embodiment, unique identifying information is displayed on each fixed-location screen 102, 104 or on groups of co-located screens 102, 104 (such as the screens 102, 104 co-located in a betting parlor). The player is required to enter the identifying information or use the identifying information to establish a connection with the gateway 120. Because the player must be close enough to a screen 102, 104 to observe the identifying information displayed thereon, if the player correctly enters the identifying information displayed on one of the screens 102, 104, the player may be assumed to be within the same state as the screen 102, 104.

The identifying information may be a character string, such as a numeric, alphabetic, alphanumeric or other string. Exemplary identifying information in the form of a string is shown at 422 in FIG. 4. Optionally or alternatively, the identifying information may include a telephone number, as shown at 424, an instant messaging address, an e-mail address or other address, by which the player may contact the game system 100. Optionally, the game system 100 may occasionally or periodically change some or all of the identifying information displayed on the fixed-location screens 102-104 to prevent a player from observing identifying information when the player is proximate one of the screens 102, 104 and later, after the player has traveled to a different state, using the previously observed identifying information to access the game system 100. For example, the game server 110 may change a displayed telephone number to a different telephone number chosen from a pool of telephone numbers. These changes may be made at regular or irregular intervals. For example, the identifying information may be revised at least once per day or more or less frequently.

In another embodiment, a geographic location of the player's mobile device 112 is ascertained, such as by a location-based server (LBS) 128 (FIG. 1) associated with the mobile telephone network 118. If the mobile device's 112 location is within a predetermined distance of the screen 102, 104 or within a predefined geographic boundary, which indicates that the mobile device 112 is within the same state as the screen 102, 104 or the game server 110 or the game system 100 (as appropriate), the player is permitted to place a bet with the game server 110. The location of the player's mobile device 112 may be ascertained for each user input, to ensure that the player remains within the prescribed geography throughout the game, or at least whenever the user provides an input to the game system 100.

Optionally, each of the screens 102-104 or groups of co-located screens 102, 104 displays unique identifying information. In this case, the player observes the identifying information displayed on one of the screens 102, 104 and enters the observed identifying information to select one of the screens 102, 104 for interaction The game server 110 uses the location-based server 128 to verify that the player's mobile device 112 is within a predetermined distance of the selected screen 102, 104. If so, the player is permitted to interact with the selected screen 102, 104, i.e., the user is permitted to play a game, which is displayed on the selected screen.

As noted, more than one mobile device 112, 126 may simultaneously interact with the game system 100. Each of these mobile devices 112, 126 may be associated with a fixed-location screen 102, 104, and the location of each mobile device 112, 126 (or the mere presence of the mobile device 112, 126 in the same state as the game server 110) may be ascertained, as described above. The mobile devices 112, 126 may each be associated with a different one of the screens 102, 104, or several mobile devices may be associated with a single screen

### Associating a Player's Input with the Player's Mobile Device

Rather than, or in addition to, associating a player's input with a fixed-location screen 102, 104, the game system 100 may associate the player's input with the player's mobile device 112. Again, if the player's mobile device's 112 location is known to be within the same state as the fixed-location screen 102, 104, the player is permitted to place a bet. However, in this case, the player associates or registers his/her mobile device 112 with the game system 100. Thereafter, the game system 100 permits the player to place a bet.

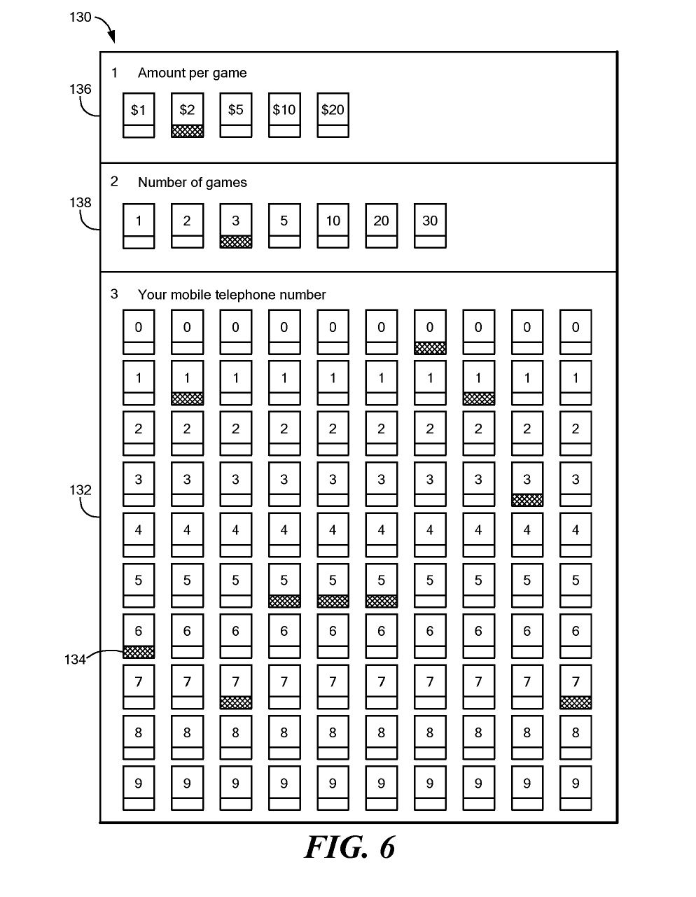

In one such embodiment, a player records the telephone number of the player's mobile device 112 on a game card 130 (FIG. 1), and a card reader/receipt printer 132 reads the game card 130. An exemplary game card 130 is shown schematically in FIG. 6. The game card 130 includes a portion 132 that contains ten columns. Each column corresponds to one of the ten digits of a telephone number Each column includes ten boxes. Each box corresponds to one of the possible numbers of the digit represented by the column. The player marks one box in each column, as indicated at 134, such as with a pencil or a pen. The game card 130 may also include a portion 136 in which the player may indicate an amount the player wishes to bet per game, as well as a portion 138 in which the player may indicate a number of games the player wishes to play.

The card reader/receipt printer 132 may use conventional optical mark recognition (OMR) technology to read the game card 130. Alternatively, the game card 130 and the card reader/receipt printer 132 may use another suitable technology, such as punched cards. Upon reading the game card 130, the game server 110 (FIG. 1) stores the telephone number of the player's mobile device 112. The player pays for one or more games, by surrendering cash or by providing information about an account that may be debited, and the card reader/receipt printer 132 prints a receipt 134. The game server 110 associates the mobile device 112 with the known geographic location of the card reader/receipt printer 132 that read the game card 130 and the fact that a payment was received for playing the game(s). This association may be made with the telephone number of the mobile device 112.

Optionally or alternatively, the player may register his/her mobile device 112 with the game system 100 and/or arrange for payment for the game(s) by calling a predetermined telephone number The game system 100 may automatically determine the telephone number of the mobile device 112 through a CLI or similar service, as described above, and store this telephone number. The player may then enter account information, such as a credit card account number or an account number of a prearranged account with the game system 100. Optionally, the game system 100 may automatically determine the account information, based on the telephone number of the calling mobile device 112. For example, the telephone number may be used to look up a previously-entered credit card or other account number in a database (not shown). The game system 100 may bill the player via a carrier-provided billing system, such as a premium-rate (so called “900”) telephone number.

In these examples, the mobile telephone number provides a form of unique identification of the player This identification may be used later to identify and authenticate a calling mobile device from which bets are placed and to verify that a player attempting to claim a prize is entitled to the prize, i.e., that the player (or the player's mobile device) is the same as the one who (or that) placed a winning bet. Thus, the mobile telephone number plays a role similar to a “digital passport,” in that the mobile telephone number may be used to identify, and verify the identity of, a person or a mobile device.

The mobile telephone number may also be thought of as playing a role similar to a HTTP “cookie.” An HTTP cookie is generated and used by a web server to differentiate users and to maintain data related to the user during navigation, possibly across multiple visits. (Unlike an HTTP cookie, the game system 100 does not generate the mobile telephone number.) However, using an automatically ascertained mobile telephone number of a calling mobile device to identify a user or the mobile device, information generated during one transaction (such as betting) may be stored in association with a person (the player) or an object (the mobile device), and the information may be used during another transaction (such as claiming a prize). The information may be stored in a central repository within the game system 100. During a subsequent interaction with the mobile device, the game system 100 may recognize the mobile device by its telephone number as having participated in a previous interaction, and the game system 100 may retrieve and use the previously-stored information in the subsequent interaction. An HTTP cookie is provided to only the server (more accurately, to servers in the same domain) that generated the cookie. Unlike an HTTP cookie, the mobile telephone number may be used by any application or server, thus activities of a mobile device user may be tracked across any number of applications, servers or domains.

The player may then dial a telephone number displayed on one of the screens 102, 104 or printed on the receipt 134 or otherwise provided to the player to access the game system 100. The game system 100 recognizes the player's mobile device 112 by its calling line identification (telephone number), because the identification matches the stored telephone number of the player's mobile device 112. Because the game system 100 recognizes the calling mobile device 112, and the game system 100 has associated the mobile device 112 with a geographic location the game system 100 allows the player to interact with screens 102, 104 that are within the same state (or in the same betting parlor or other predetermined geographic area) as the card reader/receipt printer 132 that read the player's game card 130. Because the player was physically present at the card reader/receipt printer 132 when the game card 130 was read, the player can be assumed to be in the same state (or in the same betting parlor, etc.) as the card reader/receipt printer 132 while the player plays the game, particularly because the player must watch the screen 102, 104 to interact with the screen 102, 104 and play the game.

As the player interacts with the game system 100, the player indicates game selections by pressing keys, uttering words, etc., as described above. When the game system 100 receives one of these indications of a selection from the player's mobile device 112, the game system 100 associates the received indication with the mobile device identified on the game card 130, and the game controller 110 determines a game status based on the received indication.

If the player wins the game, the player may surrender the card 130 to claim a prize, and the card reader/receipt printer 132 reads the card 130 a second time. Alternatively or optionally, the player surrenders the receipt 134 at the card reader/receipt printer 132 to claim the prize. Requiring the player to surrender the card 130 or the receipt 134 at the same card reader/receipt printer 132 as was used to produce the receipt 134 (or a co-located card reader/receipt printer) further ensures that the player remains within the state of the game system 100 throughout the game.

Optionally or alternatively, the player may claim the prize through the mobile device 112. In this case, the game system 100 recognizes the player's mobile device by the calling telephone number. The call may be the same call as the player used to interact with the game system 100 (described above), or the player may place a subsequent call to claim the prize. The game system 100 may credit the player's account (which is associated with the mobile device telephone number), or the player may enter information that enables the game system 100 to send the prize to the player, such as via postal mail to the player's home address. Using the telephone number of the player's mobile device 112 to identify the player while he/she plays the game and when he/she claims the prize avoids a possibility of loss or theft of a winning physical card, such as a “scratch card.”

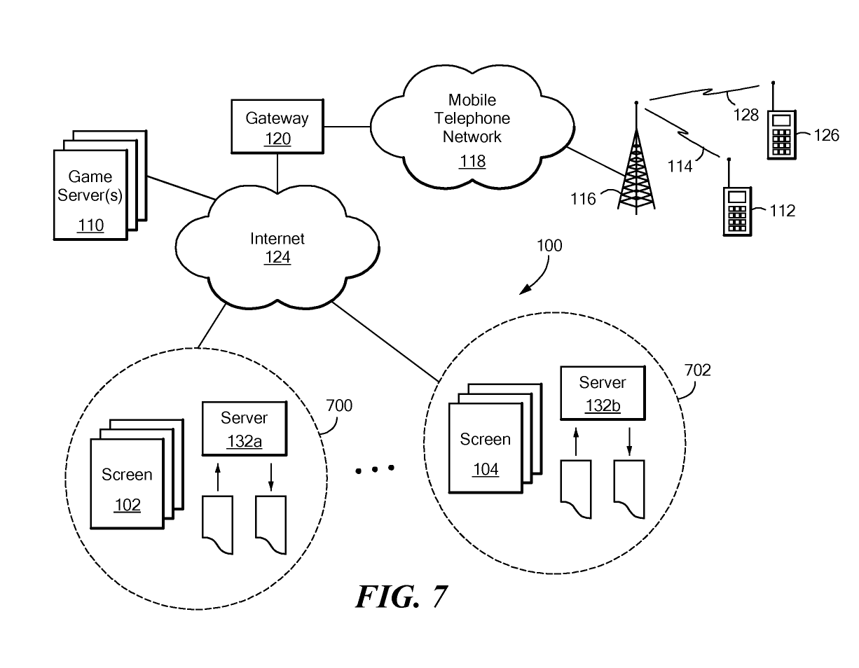

As noted, game indicia may be displayed on more than one screen 102, 104. When a player's mobile telephone 112 calls the gateway 120 and the player indicates a selection of a game option (as described above), the game server 110 may associate the received indication with one, or fewer than all, of the screens 102, 104. For example, as shown in FIG. 7, the game system 100 may include two or more betting parlors 700 and 702, and the screens 102, 104 may be located in distinct game parlors 700 and 702. Thus, the game server 110 may associate the received indication with one or more of the screens 102 in one of the betting parlors 700, i.e., the betting parlor where the player's mobile device 112 is located.

It should be noted that the betting parlors 700 and 702 may be located in separate states. In this case, it may be necessary to have separate game servers 110 located in each state.

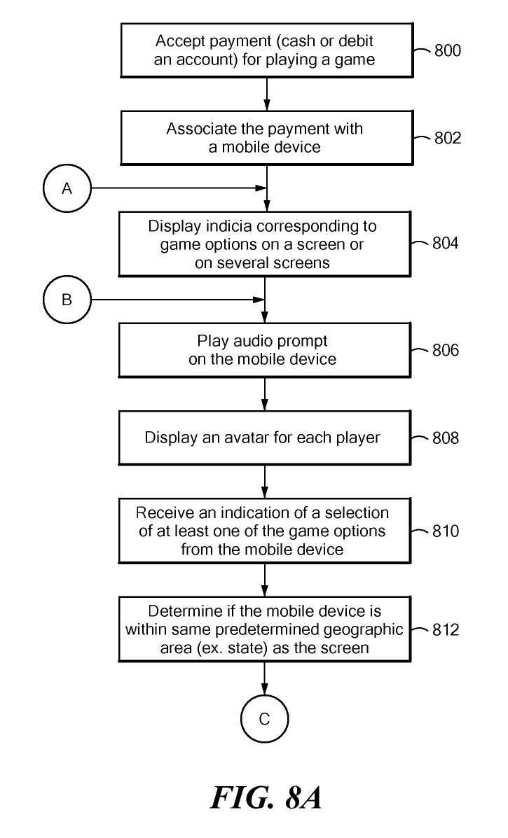

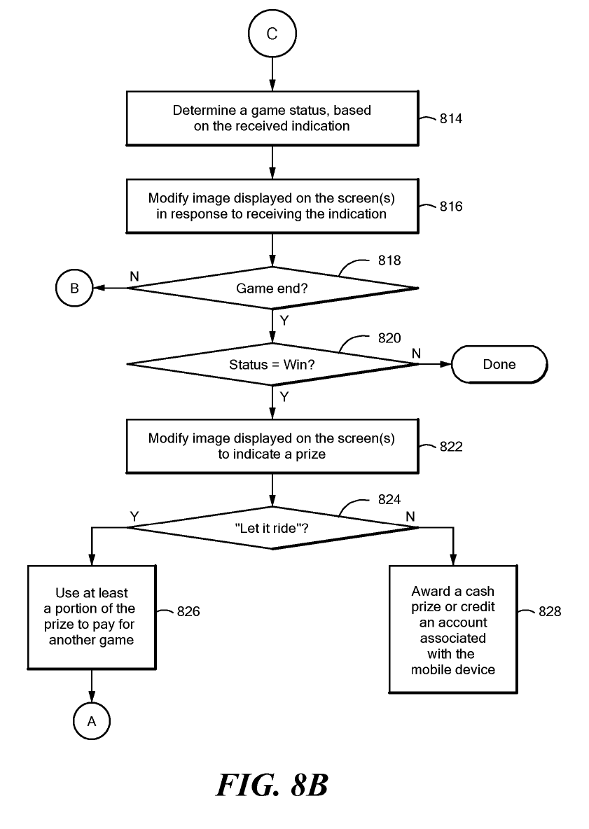

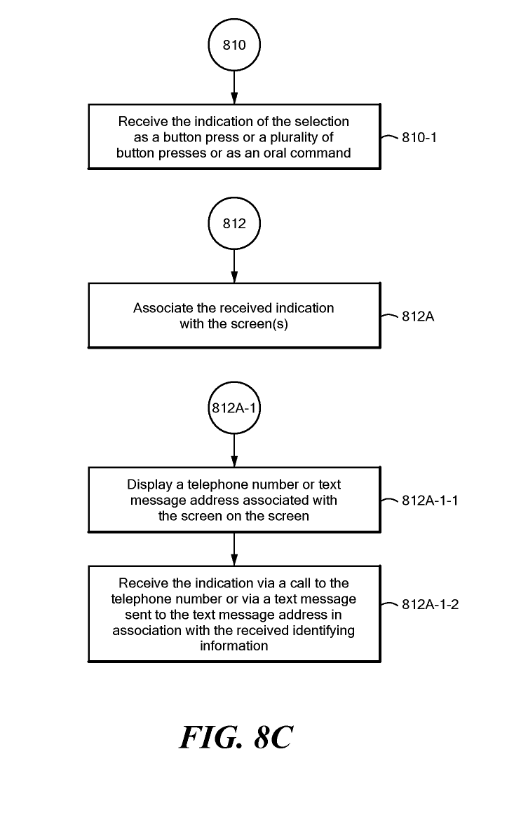

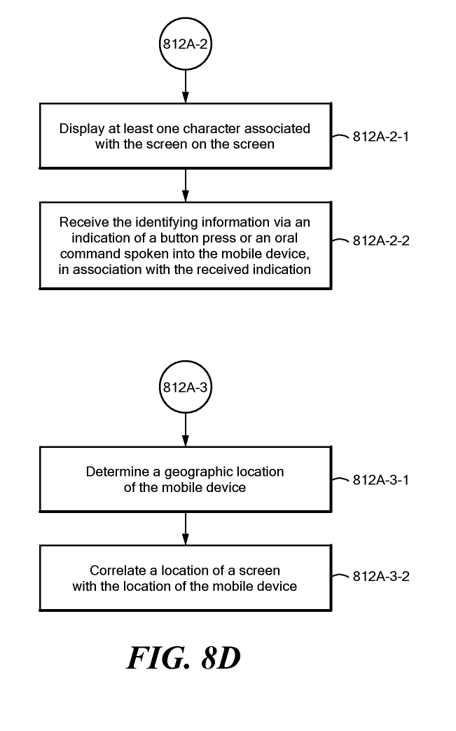

FIG. 8A-D is a flowchart illustrating operation of a game system, according to one embodiment of the present invention. It should be noted that some of the operations depicted in the flowchart are optional. In addition, the order of some of the operations depicted in a flowchart may be changed; that is, some of the operations depicted in the flowchart maybe reordered.

At 800, the game system accepts payment, in the form of cash or by debiting an account, for playing a game, and at 802 the system associates the payment with a mobile device. The mobile device's mobile telephone number or mobile identification number (MIN) may, for example, be used to associate the payment with the mobile device.

At 804, indicia corresponding to game options are displayed on a screen or on several screens, and at 806 an audio prompt may be played on the mobile device. In addition at 808, for each player, the system may display an avatar on the screen.

As noted, a player interacts with the system with a mobile device. At 810, the system receives an indication of a selection of at least one of the game options (that were displayed at 804) from the mobile device. At 812, the system determines if the mobile device is within a same predetermined geographic area (such as a state) as the screen (or several screens) or, if appropriate, the same geographic area as the game server 110.

At 814, the system determines a game status, based on the received indication. At 816, the system may modify an image displayed on the screen(s), in response to receiving the indication. At 818, if the game has not yet ended, control returns to 806. On the other hand, if the game has ended, control passes to 820.

At 820, if the game status does not indicate a win the operation is done. On the other hand, if the game status indicates a win, at 822 the system may modify an image displayed on the screen(s) to indicate a prize. If, at 824, the player chooses to “let it (the prize) ride,” control passes to 826, where at least a portion of the prize is used to pay for another game, and control returns to 804. On the other hand, if the player does not choose to “let it ride,” control passes to 828, where a cash prize is awarded or an account associated with a mobile device is credited with the prize.

As shown in FIG. 8C, receiving an indication of a selection of at least one of the game options (i.e., operation 810, described above) may include receiving the indication of the selection as an indication of a button press or a plurality of button presses on the mobile device or as an oral command spoken into the mobile device, as shown at 810-1.

Determining if the mobile device is within the same geographic area as the screen or the game server (i.e., operation 812, described above) may include associating the received indication with the screen (or several screens), as shown at 812A.

Associating the received indication with the screen (or several screens) (operation 812A) may include displaying a telephone number or text message address associated with the screen(s) on the screen(s), as shown at 812A-1-1, and receiving the indication via a call to the telephone number, or via a text message sent to the text message address, in association with the received identifying information, as shown at 812A-1-2.

Alternatively or optionally, as shown in FIG. 8D, associating the received indication with the screen (or several screens) may include displaying at least one character associated with the screen(s) on the screen(s), as shown at 812A-2-1, and receiving the identifying information via an indication of a button press or an oral command spoken into the mobile device, in association with the received indication as shown at 812A-2-2.

Alternatively or optionally, associating the received indication with the screen (or several screens) may include determining a geographic location of the mobile device, as shown at 812A-3-1, and correlating the location of the screen(s) with the location of the mobile device, as shown at 812A-3-2.

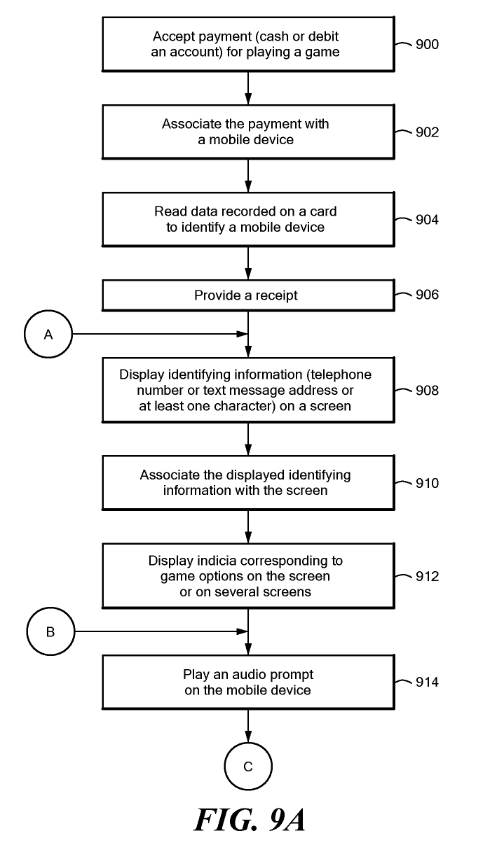

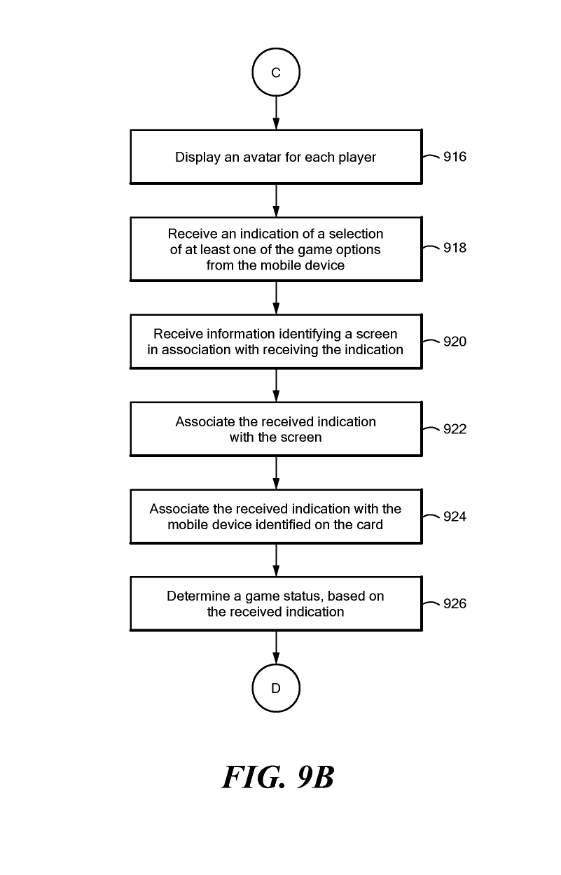

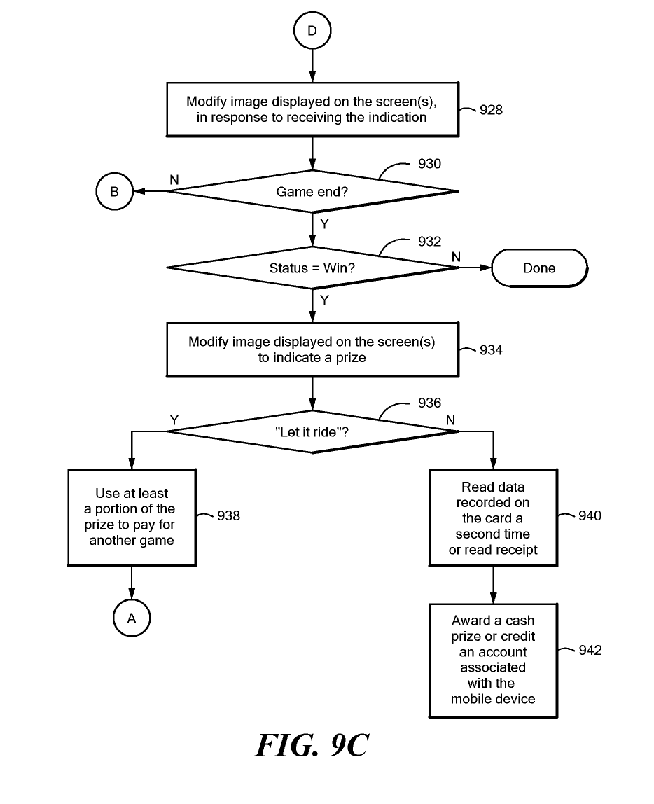

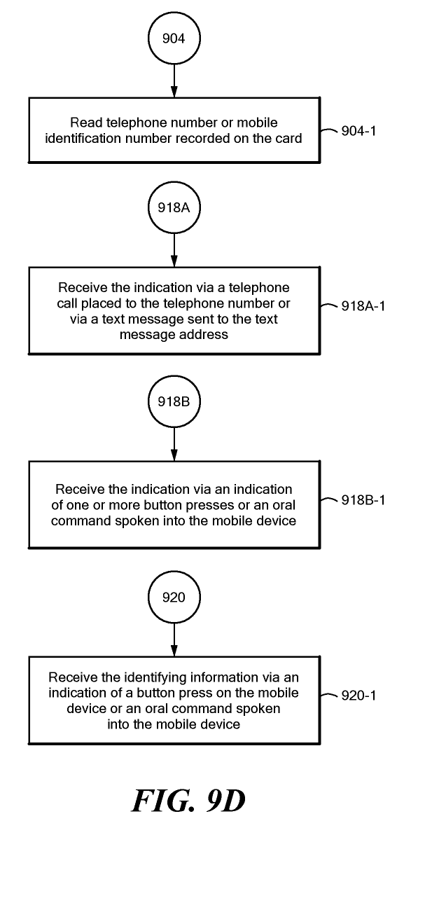

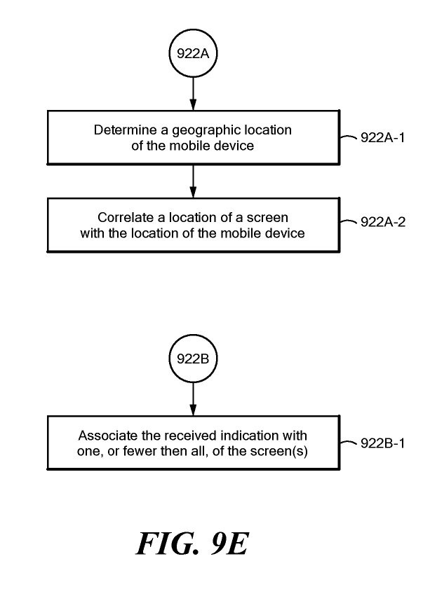

FIGS. 9A-E is a flowchart illustrating operation of a game system, according to another embodiment of the present invention At 900, the game system accepts payment, in the form of cash or by debiting an account, for playing the game, and at 902 the system associates the payment with a mobile device. The mobile device's mobile telephone number or mobile identification number (MIN) may, for example, be used to associate the payment with the mobile device.

At 904, the system reads a card, on which data identifying the mobile device has been recorded. The system provides a receipt at 906.

At 908, identifying information, such as a telephone number or a text message address or at least one character, is displayed on a screen At 910, the displayed identifying information is associated with the screen.

At 912, indicia corresponding to game options are displayed on the screen or on several screens, and at 914 an audio prompt may be played on the mobile device. In addition at 916, for each player, the system may display an avatar on the screen

At 918, the system receives an indication of a selection of at least one of the game options (that were displayed at 908) from the mobile device.

At 920, the system may receive information identifying a screen in association with receiving the indication of the selection of the game option, and, at 922, the system may associate the received indication with the screen.

At 924, the system associates the received indication of the selection of the game option with the mobile device identified on the card, and at 926, the system determines a game status based on the received indication. The system may modify an image displayed on the screen(s), in response to receiving the indication, at 928. At 930, if the game has not yet ended, control returns to 914. On the other hand, if the game has ended, control passes to 932.

At 932, if the game status does not indicate a win the operation is done. On the other hand, if the game status indicates a win, at 934 the system may modify an image displayed on the screen(s) to indicate a prize. If, at 936, the player chooses to “let it ride,” control passes to 938, where at least a portion of the prize is used to pay for another game, and control returns to 908. On the other hand, if the player does not choose to “let it ride,” control passes to 940. At 940, the system may read data recorded on the card a second time or read the receipt. At 942, a cash prize is awarded or an account associated with the mobile device is credited with the prize.

As shown in FIG. 9D, reading the data recorded on the card to identify the mobile device (i.e., operation 904, described above) may include reading a telephone number or a mobile identification number recorded on the card, as shown at 904-1.

Receiving the indication of the selection of the at least one of the game options (i.e. operation 918, described above) may include receiving the indication via a telephone call placed to the telephone number or via a text message sent to the text message address, as shown at 918A-1.

Alternatively or optionally, receiving the indication of the selection may include receiving the indication via an indication of one or more button presses or an oral command spoken to the mobile device, as shown at 918B-1.

Receiving the information identifying the screen in association with receiving the indication (i.e., operation 920, described above) may include receiving the identifying information via an indication of a button press on the mobile device or an oral command spoken into the mobile device, as shown at 920-1.

As shown in FIG. 9E, associating the received indication with the screen (i.e., operation 922, described above) may include determining a geographic location of the mobile device, as shown at 922A-1, and correlating a location of a screen with the location of the mobile device, as shown at 922A-2.

Alternatively or optionally, associating the received indication with the screen may include associating the received indication with one, or fewer than all, of the screen(s), as shown at 922B-1.

Although the game system 100 has been described as using a mobile device's 112 telephone number to identify the mobile device or to distinguish two mobile devices 112, 126, other information available to the gateway 120 or the game server 110 may be used to identify or distinguish the mobile device. Examples of such information include a portion of the mobile device's telephone number, the mobile device's mobile identification number (MIN), a mobile device account number, information stored on a subscriber identity module (SIM) within the mobile device, an SMS address, an IM address, an e-mail address or any other information available to the gateway 120 or the game server 110.

The game system 100 may be used to play a wide variety of games, such as bingo, and various lotteries. In addition, the game system 100 may select game options on behalf of the player. For example, the player may choose to have the game system 100 randomly select a set of “quick pick” numbers for a Keno game.

Various components of the game system 100 may be combined, and individual components of the game system 100 may be implemented by a combination of units. For example, the functionality of the game server 110, the gateway 120 and/or the screen clients 106-108 may be combined in a single server or “blade” system Servers, blades, proxies, clients and the like include processors controlled by instructions stored in memories, as is well known in the art.

Although the game server 110 is described as a single server, the game server 110 may be implemented as a set of servers. Similarly, some of the game servers may be located in different states than other of the game servers. Some of the screens 102-104 may be located in different states and other of the screens 102-104. Thus, the game system 100 may provide opportunities for players in several states to place bets with game servers 110 located in the same states as the respective players.

A game system has been described as including a processor controlled by instructions stored in a memory. The memory may be random access memory (RAM), read-only memory (ROM), flash memory or any other memory, or combination thereof, suitable for storing control software or other instructions and data. Some of the functions performed by the game system have been described with reference to flowcharts. Those skilled in the art should readily appreciate that functions, operations, decisions, etc. of all or a portion of each block, or a combination of blocks, of the flowcharts may be implemented as computer program instructions, software, hardware, firmware or combinations thereof Those skilled in the art should also readily appreciate that instructions or programs defining the functions of the present invention may be delivered to a processor in many forms, including, but not limited to, information permanently stored on non-writable, computer-readable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including computer networks. In addition, while the invention may be embodied in software, the functions necessary to implement the invention may alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. Moreover, while the preferred embodiments are described in connection with various illustrative data structures, one skilled in the art will recognize that the system may be embodied using a variety of data structures. Furthermore, disclosed aspects, or portions of these aspects, may be combined in ways not listed above. Accordingly, the invention should not be viewed as limited by the exemplary embodiments described above. Any reference numerals or letters in the claims are for reference purposes only and do not necessarily imply an order of elements or operations.

What is claimed is:

1. A method for operating a game, comprising:
(a) displaying indicia corresponding to a plurality of game options on a fixed-location screen;
(b) receiving an indication of a selection of at least one of the plurality of game options from a mobile device via a wireless link;
(c) determining if the mobile device is within a predetermined geographic area that contains the fixed-location screen; and
(d) if the mobile device is within the predetermined geographic area, determining a game status based on the received indication.

2. A method according to claim 1, wherein determining if the mobile device is within a predetermined geographic area comprises associating the received indication with the fixed-location screen.

3. A method according to claim 2, wherein associating the received indication with the fixed-location screen comprises:
displaying identifying information associated with the fixed-location screen on the fixed-location screen; and
receiving the identifying information in association with the received indication.

4. A method according to claim 3, further comprising repeatedly revising the displayed identifying information.

5. A method according to claim 3, further comprising revising the displayed identifying information at least once per day.

6. A method according to claim 3, wherein:
displaying the identifying information comprises displaying a telephone number; and
receiving the indication comprises receiving the indication of the selection of the at least one of the plurality of game options via a telephone call placed by the mobile device to the telephone number.

7. A method according to claim 3, wherein:
displaying the identifying information comprises displaying a text message address; and
receiving the indication comprises receiving the indication of the selection of the at least one of the plurality of game options via a text message sent by the mobile device to the text message address.

8. A method according to claim 3, wherein:
displaying the identifying information comprises displaying at least one character; and
receiving the identifying information comprises receiving an indication of a button press on the mobile device corresponding to each of the at least one character.

9. A method according to claim 3, wherein:
displaying the identifying information comprises displaying at least one character; and
receiving the identifying information comprises receiving an oral command corresponding to the at least one character and spoken into the mobile device.

10. A method according to claim 2, wherein associating the received indication with the fixed-location screen comprises:
determining a geographic location of the mobile device; and
correlating a location of the fixed-location screen with the location of the mobile device.

11. A method according to claim 1, wherein receiving the indication of the selection comprises receiving an indication of a button press on the mobile device.

12. A method according to claim 1, wherein receiving the indication of the selection comprises receiving a plurality of mobile device button press indications.

13. A method according to claim 1, wherein receiving the indication of the selection comprises receiving an oral command spoken into the mobile device.

14. A method according to claim 1, further comprising modifying an image displayed on the fixed-location screen in response to receiving the indication of the selection.

15. A method according to claim 1, further comprising, if the game status indicates a win, modifying an image displayed on the fixed-location screen.

16. A method according to claim 15, wherein modifying the image comprises displaying an indication of a prize associated with the win.

17. A method according to claim 1, further comprising:
accepting a payment for playing the game; and
associating the payment with the mobile device.

18. A method according to claim 1, further comprising debiting an account associated with the mobile device for playing the game.

19. A method according to claim 1, further comprising, if the game status indicates a win, awarding a prize.

20. A method according to claim 1, further comprising, if the game status indicates a win, crediting an account associated with the mobile device with a prize.

21. A method according to claim 1, further comprising, if the game status indicates a win, allocating at least a portion of a prize associated with the win to a cost associated with a subsequent game.

22. A method according to claim 1, further comprising repeating (b) and (d) until the game status corresponds to an end of the game.

23. A method according to claim 2, wherein:
displaying the indicia comprises displaying the indicia corresponding to the plurality of game options on each of a plurality of fixed-location screens; and
associating the received indication comprises associating the received indication with one of the plurality of fixed-location screens.

24. A method according to claim 2, wherein:
displaying the indicia comprises displaying the indicia corresponding to the plurality of game options on each of a plurality of fixed-location screens; and
associating the received indication comprises associating the received indication with fewer than all of the plurality of fixed-location screens.

25. A method according to claim 1, further comprising sending an audio signal via the wireless link to the mobile device for rendition thereby, the audio signal comprising a verbal prompt related to selecting the at least one of the plurality of game options.

26. A method according to claim 2, further comprising:
receiving a second indication of a second selection of at least one of the plurality of game options from a second mobile device via a second wireless link;
associating the received second indication with the fixed-location screen; and
determining a second game status based on the received second indication.

27. A method according to claim 26, further comprising distinguishing the received indication from the second received indication based on a first calling telephone number associated with the mobile device and a second calling telephone number associated with the second mobile device.

28. A method according to claim 26, further comprising automatically determining the first calling telephone number and the second calling telephone number.

29. A method according to claim 26, further comprising distinguishing the received indication from the second received indication based on a first mobile identification number associated with the mobile device and a second mobile identification number associated with the second mobile device.

30. A method according to claim 26, further comprising:
displaying a first avatar on the fixed-location screen to represent a first user of the mobile device; and
displaying a second avatar, different than the first avatar, on the fixed-location screen to represent a second user of the second mobile device.

31. A method for operating a game, comprising:
storing identifying information about a wireless mobile device;
receiving an indication of a selection of at least one game option from the mobile device via a wireless link;
determining a game status based on the received indication; and
if the game status indicates a win, using the stored identifying information to award a prize.

32. A method according to claim 31, further comprising displaying indicia corresponding to a plurality of game options on a fixed-location screen.

33. A method according to claim 31, wherein storing the identifying information comprises storing at least a portion of a telephone number of the wireless mobile device.

34. A method according to claim 31, wherein storing the identifying information comprises storing at least a portion of a text messaging address of the wireless mobile device.

35. A method for operating a game, comprising:
(a) reading data recorded on a card, the data identifying a mobile device;
(b) displaying indicia corresponding to a plurality of game options on a fixed-location screen;
(c) receiving an indication of a selection of at least one of the plurality of game options from the mobile device via a wireless link;
(d) associating the received indication with the mobile device identified by the data recorded on the card; and
(e) determining a game status based on the received indication.

36. A method according to claim 35, further comprising:
determining if the mobile device is within a predetermined geographic area that contains the fixed-location screen; and
wherein determining the game status comprises if the mobile device is within the predetermined geographic area, determining the game status based on the received indication.

37. A method according to claim 35, wherein:
receiving the indication comprises receiving the indication of the selection of the at least one of the plurality of game options via a communication from the mobile device; and
associating the received indication with the mobile device comprises correlating the read data recorded on the card with information provided in association with the communication from the mobile device.

38. A method according to claim 37, wherein:
reading data recorded on a card comprises reading a telephone number of the mobile device recorded on the card; and
associating the received indication with the mobile device comprises correlating the read telephone number of the mobile device recorded on the card with a calling telephone number provided in association with the communication from the mobile device.

39. A method according to claim 37, wherein:
reading data recorded on a card comprises reading a mobile identification number of the mobile device recorded on the card; and
associating the received indication with the mobile device comprises correlating the read mobile identification number of the mobile device recorded on the card with a mobile identification number provided in association with the communication from the mobile device.

40. A method according to claim 37, wherein:
reading data recorded on a card comprises reading a text messaging address of the mobile device recorded on the card; and
associating the received indication with the mobile device comprises correlating the read text messaging address of the mobile device recorded on the card with a sending text messaging address provided in association with the communication from the mobile device.

41. A method according to claim 35, further comprising:
displaying identifying information associated with the fixed-location screen on the fixed-location screen; and
receiving the identifying information in association with the received indication.

42. A method according to claim 41, wherein:
displaying the identifying information comprises displaying a telephone number; and
receiving the indication comprises receiving the indication of the selection of the at least one of the plurality of game options via a telephone call placed by the mobile device to the telephone number.

43. A method according to claim 41, wherein:
displaying the identifying information comprises displaying a text message address; and
receiving the indication comprises receiving the indication of the selection of the at least one of the plurality of game options via a text message sent by the mobile device to the text message address.

44. A method according to claim 41, wherein:
displaying the identifying information comprises displaying at least one character; and
receiving the identifying information comprises receiving an indication of a button press on the mobile device corresponding to each of the at least one character.

45. A method according to claim 41, wherein:
displaying the identifying information comprises displaying at least one character; and
receiving the identifying information comprises receiving an oral command corresponding to the at least one character and spoken into the mobile device.

46. A method according to claim 35, further comprising associating the received indication with the fixed-location screen.

47. A method according to claim 46, wherein associating the received indication with the fixed-location screen comprises:
displaying identifying information associated with the fixed-location screen on the fixed-location screen; and
receiving the identifying information in association with the received indication.

48. A method according to claim 47, wherein:
displaying the identifying information comprises displaying a telephone number; and
receiving the indication comprises receiving the indication of the selection of the at least one of the plurality of game options via a telephone call placed by the mobile device to the [displayed] telephone number.

49. A method according to claim 47, wherein:
displaying the identifying information comprises displaying a text message address; and
receiving the indication comprises receiving the indication of the selection of the at least one of the plurality of game options via a text message sent by the mobile device to the [displayed] text message address.

50. A method according to claim 47, wherein:
displaying the identifying information comprises displaying at least one character; and
receiving the indication comprises receiving an indication of a button press on the mobile device corresponding to each of the at least one character.

51. A method according to claim 47, wherein:
displaying the identifying information comprises displaying at least one character; and
receiving the indication comprises receiving an oral command corresponding to the at least one character and spoken into the mobile device.

52. A method according to claim 46, wherein associating the received indication with the fixed-location screen comprises:
determining a geographic location of the mobile device; and
correlating a location of the fixed-location screen with the location of the mobile device.

53. A method according to claim 46, wherein:
displaying the indicia comprises displaying the indicia corresponding to the plurality of game options on each of a plurality of fixed-location screens; and
associating the received indication comprises associating the received indication with one of the plurality of fixed-location screens.

54. A method according to claim 46, wherein:
displaying the indicia comprises displaying the indicia corresponding to the plurality of game options on each of a plurality of fixed-location screens; and
associating the received indication comprises associating the received indication with fewer than all of the plurality of fixed-location screens.

55. A method according to claim 35, wherein receiving the indication of the selection comprises receiving an indication of a button press on the mobile device.

56. A method according to claim 35, wherein receiving the indication of the selection comprises receiving a plurality of mobile device button press indications.

57. A method according to claim 35, wherein receiving the indication of the selection comprises receiving an oral command spoken into the mobile device.

58. A method according to claim 35, further comprising modifying an image displayed on the fixed-location screen in response to receiving the indication of the selection.

59. A method according to claim 35, further comprising, if the game status indicates a win, modifying an image displayed on the fixed-location screen.

60. A method according to claim 59, wherein modifying the image comprises displaying an indication of a prize associated with the win.

61. A method according to claim 35, further comprising:
accepting a payment for playing the game; and
associating the payment with the mobile device.

62. A method according to claim 35, further comprising debiting an account associated with the mobile device for playing the game.

63. A method according to claim 35, further comprising, if the game status indicates a win, awarding a prize.

64. A method according to claim 35, further comprising, if the game status indicates a win, crediting an account associated with the mobile device with a prize.

65. A method according to claim 35, further comprising, if the game status indicates a win, allocating at least a portion of a prize associated with the win to a cost associated with a subsequent game.

66. A method according to claim 35, further comprising repeating (c), (d) and (e) until the game status corresponds to an end of the game.

67. A method according to claim 35, further comprising sending an audio signal via the wireless link to the mobile device for rendition thereby, the audio signal comprising a verbal prompt related to selecting the at least one of the plurality of game options.

68. A method according to claim 35, further comprising:
reading second data recorded on a second card, the second data identifying a second mobile device;
receiving a second indication of a second selection of at least one of the plurality of game options from a second mobile device via a second wireless link;
associating the received second indication with the second mobile device identified by the second data recorded on the second card; and
determining a second game status based on the received second indication.

69. A method according to claim 68, further comprising distinguishing the received indication from the second received indication based on a first calling telephone number associated with the mobile device and a second calling telephone number associated with the second mobile device.

70. A method according to claim 68, further comprising automatically determining the first calling telephone number and the second calling telephone number.

71. A method according to claim 68, further comprising distinguishing the received indication from the second received indication based on a first mobile identification number associated with the mobile device and a second mobile identification number associated with the second mobile device.

72. A method according to claim 68, further comprising:
displaying a first avatar on the fixed-location screen to represent a first user of the mobile device; and
displaying a second avatar, different than the first avatar, on the fixed-location screen to represent a second user of the second mobile device.

73. A method according to claim 35, wherein reading the data comprises reading a telephone number of the mobile device recorded on the card.

74. A method according to claim 35, wherein reading the data comprises reading a mobile identification number of the mobile device recorded on the card.

75. A method according to claim 35, further comprising:
reading the data recorded on the card a second time;
if the status indicates a win, awarding a prize in response to reading the data recorded on the card the second time.

76. A method according to claim 35, further comprising:
providing a receipt associated with the mobile device identified by the data recorded on the card;
reading data recorded on the receipt;
if the status indicates a win, awarding a prize in response to reading the data recorded on the receipt.

77. A game system for interacting with a mobile device via a wireless network, comprising:
a gateway for coupling to the wireless network;
a fixed-location display screen; and
a game server coupled to the gateway and to the fixed-location display screen and programmed to:
display indicia corresponding to a plurality of game options on the display screen;
receive an indication of a selection of at least one of the plurality of game options from the mobile device via the wireless network;
determine if the mobile device is within a predetermined geographic area that contains the fixed-location screen; and
if the mobile device is within the predetermined geographic area, determine a game status based on the received indication.

78. A game system according to claim 77, wherein the game server is further programmed to associate the received indication with the fixed-location screen.

79. A game system according to claim 78, wherein the game server is further programmed to associate the received indication with the fixed-location screen by:
displaying identifying information associated with the fixed-location screen on the fixed-location screen; and
receiving the identifying information in association with the received indication.

80. A game system according to claim 79, wherein the displayed identifying information comprises a telephone number.

81. A game system according to claim 79, wherein the displayed identifying information comprises a text message address.

82. A game system according to claim 79, wherein the displayed identifying information comprises at least one character.

83. A game system according to claim 77, further comprising:
a card reader coupled to the game server and operative to read data recorded on a card, the data identifying the mobile device;
wherein the game server is further programmed to associate the received indication with the mobile device identified by the data recorded on the card.

84. A game system according to claim 83, wherein the data identifying the mobile device comprises a telephone number.

85. A game system according to claim 83, wherein the data identifying the mobile device comprises a mobile identification number (MIN).

86. A game system according to claim 83, wherein the data identifying the mobile device comprises a text messaging address.
